(19) United States
(12) Patent Application Publication
(10) Pub. No.: US 2013/0062086 A1
(43) Pub. Date: Mar. 14, 2013

(54) POWER TOOL

(71) Applicants: Yutaka Ito, Hitachinaka (JP); Katsuhiro Oomori, Hitachinaka (JP); Mizuho Nakamura, Hitachinaka (JP); Tomomasa Nishikawa, Hitachinaka (JP); Hironori Mashiko, Hitachinaka (JP)

(72) Inventors: Yutaka Ito, Hitachinaka (JP); Katsuhiro Oomori, Hitachinaka (JP); Mizuho Nakamura, Hitachinaka (JP); Tomomasa Nishikawa, Hitachinaka (JP); Hironori Mashiko, Hitachinaka (JP)

(73) Assignee: HITACHI KOKI CO., LTD., Tokyo (JP)

(21) Appl. No.: 13/698,231

(22) PCT Filed: Apr. 12, 2011
(86) PCT No.: PCT/JP2011/059469

§ 371 Date: Nov. 15, 2012

(30) Foreign Application Priority Data
May 31, 2010 (JP) 2010-125378

(51) Int. Cl. B25B 21/02; B25B 23/147

(52) U.S. Cl. 173/1; 173/2

(57) ABSTRACT

The present invention provides a power tool for tightening a fastener. The power tool includes a motor, a hammer, an anvil, and a control unit. The hammer is intermittently or continuously rotatable in a forward direction by the motor. The anvil is impacted by the hammer rotated in the forward direction. The control unit controls the hammer to continuously rotate at a first number of rotations, and to intermittently rotate at a second number of rotations lower than the first number of rotations when a prescribed time has elapsed from the rotation of the hammer at the first number of rotations, and then to intermittently rotate at a third number of rotations lower than the second number of rotations when a predetermined time has elapsed from the rotation of the hammer at the second number of rotations.

### CROSS REFERENCE TO RELATED APPLICATION

This application claims priority from Japanese Patent Application No. 2010-125378 filed May 31, 2010. The entire content of this priority application is incorporated herein by reference.

### TECHNICAL FIELD

The present invention relates to a power tool, and more particularly to an electronic pulse driver that outputs a rotary drive force.

### BACKGROUND ART

A conventional power tool primary includes a hammer rotating in a single direction and an anvil impacted by the hammer in the same direction.

### CITATION LIST

### Patent Literature

PLT1: Japanese Patent Application Publication No. 2008-307664

### SUMMARY OF INVENTION

### Technical Problem

The inventors of the present invention developed a new type of an electronic pulse driver with a hammer capable of rotating in forward and reverse directions for striking an anvil. When the electronic pulse driver tightens a self-drilling screw having a drill part at its tip end portion into a steel plate, the self-drilling screw must be rotated at high speed, so that the drill part can form a bore as a pilot hole.

However, if the high speed rotation of the self-drilling screw has been maintained after a threaded part of the self-drilling screw is screwed into the steel plate, a head of the self-drilling screw may be disengaged from an end tool (bit) upon seating the self-drilling screw on the steel plate. As a result, the head of the self-drilling screw may be stripped or broken.

It is an object of the present invention to provide a power tool capable of preventing a head of a fastener from being broken.

### Solution to Problem

This and other objects of the present invention will be attained by a power tool. The power tool for tightening a fastener includes a motor, a hammer, an anvil, and a control unit. The hammer is intermittently or continuously rotatable in a forward direction by the motor. The anvil is impacted by the hammer rotated in the forward direction. The control unit controls the hammer to continuously rotate at a first number of rotations, and to intermittently rotate at a second number of rotations lower than the first number of rotations when a prescribed time has elapsed from the rotation of the hammer at the first number of rotations, and then to intermittently rotate at a third number of rotations lower than the second number of rotations when a predetermined time has elapsed from the rotation of the hammer at the second number of rotations.

With this configuration, the control unit controls the hammer to continuously rotate at the first number of rotations, and to intermittently rotate at the second number of rotations when the prescribed time has elapsed, and then to intermittently rotate at the third number of rotations when the predetermined time has elapsed, thereby preventing the fastener from being supplied to an excessive torque.

It is preferable that the power tool further includes a detecting unit configured to detect an electric current flowing to the motor, and the control unit controls the hammer to intermittently rotate at the second number of rotation when the electric current detected by the detecting unit exceeds a prescribed value, and the control unit controls the hammer to intermittently rotate at the third number of rotation when a rate of increase in the electric current detected by the detecting unit exceeds a predetermined value.

With this configuration, since the fastening state of the fastener is determined based on the electric current detected by the detecting unit, the number of rotations of the motor is decreased in a step-by-step manner according to the fastening state.

It is preferable that the hammer is rotatable alternately in the forward direction and a reverse direction by the motor, and the control unit controls the hammer to continuously rotate in the forward direction at the first number of rotations, and to rotate alternately in the forward direction and the reverse direction at the second number of rotations when the prescribed time has elapsed from the rotation of the hammer at the first number of rotations, and then to rotate alternately in the forward direction and the reverse direction at the third number of rotations when the predetermined time has elapsed from the rotation of the hammer at the second number of rotations.

With this configuration, the power tool can tighten the fastener at higher torque when the hammer is rotatable alternately in the forward and reverse directions than when the hammer is rotatable only in the forward direction.

It is preferable that the control unit controls the hammer to intermittently rotate at the third number of rotations when the fastener is seated on a workpiece.

With this configuration, the power tool can avoid breaking or stripping a head of the fastener due to a bit applying excessive torque to the same.

According to another aspect, the present invention provides a power tool. The power tool includes a motor, a hammer, an anvil, and a control unit. The hammer is intermittently or continuously rotatable in a forward direction by the motor. The anvil is impacted by the hammer rotated in the forward direction. The control unit controls the hammer to continuously rotate at a first rotational velocity, and to intermittently rotate at a second rotational velocity lower than the first rotational velocity when a prescribed time has elapsed from the rotation of the hammer at the first rotational velocity, and then to intermittently rotate at a third rotational velocity lower than the second rotational velocity when a predetermined time has elapsed from the rotation of the hammer at the second rotational velocity.

With this configuration, the control unit controls the hammer to continuously rotate at the first rotational velocity, and to intermittently rotate at the second rotational velocity when the prescribed time has elapsed, and then to intermittently rotate at the third rotational velocity when the predetermined time has elapsed, thereby preventing the fastener from being supplied to an excessive torque.

It is preferable that the power tool further includes a detecting unit configured to detect an electric current flowing to the motor, and the control unit controls the hammer to intermittently rotate at the second rotational velocity when the electric current detected by the detecting unit exceeds a prescribed value, and the control unit controls the hammer to intermittently rotate at the third rotational velocity when a rate of increase in the electric current detected by the detecting unit increases to a predetermined value.

With this configuration, since the fastening state of the fastener is determined based on the electric current detected by the detecting unit, the rotational velocity of the motor is decreased in a step-by-step manner according to the fastening state.

It is preferable that the hammer is rotatable alternately in the forward direction and a reverse direction by the motor, and the control unit controls the hammer to continuously rotate in the forward direction at the first rotational velocity, and to rotate alternately in the forward direction and the reverse direction at the second rotational velocity when the prescribed time has elapsed from the rotation of the hammer at the first rotational velocity, and then to rotate alternately in the forward direction and the reverse direction at the third rotational velocity when the predetermined time has elapsed from the rotation of the hammer at the second rotational velocity.

With this configuration, the power tool can tighten the fastener at higher torque when the hammer is rotatable alternately in the forward and reverse directions than when the hammer is rotatable only in the forward direction.

It is preferable that the control unit controls the hammer to intermittently rotate at the third rotational velocity when the fastener is seated on a workpiece.

With this configuration, the power tool can avoid breaking or stripping a head of the fastener due to a bit applying excessive torque to the same.

According to still another aspect, the present invention provides a power tool. The power tool for tightening a fastener includes a motor, a hammer, an anvil, and a power supply unit. The hammer is intermittently or continuously rotatable in a forward direction by the motor. The anvil is impacted by the hammer rotated in the forward direction. The power supply unit continuously supplies an electric power to the motor, and then intermittently supplies the electric power to the motor in a first cycle when a prescribed time has elapsed from continuously supply of the electric power, and then intermittently supplies the electric power to the motor in a second cycle shorter than the first cycle when a predetermined time has elapsed from intermittently supply of the electric power in the first cycle.

With this configuration, since the power supply unit supplies the electric power to the motor in the second cycle at a final phase of a fastening operation, a torque applied to the fastener can be lowered.

According to still another aspect, the present invention provides a method for tightening a fastener using a power tool, the power tool including a motor, a hammer intermittently or continuously rotatable in a forward direction by the motor, and an anvil that is impacted by the hammer rotated in the forward direction, the method including, first controlling the hammer to continuously rotate at a first number of rotations, second controlling the hammer to intermittently rotate at a second number of rotations lower than the first number of rotations when a prescribed time has elapsed from the first controlling, and third controlling the hammer to intermittently rotate at a third number of rotations lower than the second number of rotations when a predetermined time has elapsed from second controlling.

With this configuration, the method includes first controlling the hammer to continuously rotate at the first number of rotations, second controlling the hammer to intermittently rotate at the second number of rotations when the prescribed time has elapsed, and third controlling the hammer to intermittently rotate at the third number of rotations when the predetermined time has elapsed, thereby preventing the fastener from being supplied to an excessive torque.

According to still another aspect, the present invention provides a method for tightening a fastener using a power tool, the power tool including a motor, a hammer intermittently or continuously rotatable in a forward direction by the motor, and an anvil that is impacted by the hammer rotated in the forward direction, the method including first controlling the hammer to continuously rotate at a first rotational velocity, second controlling the hammer to intermittently rotate at a second rotational velocity lower than the first rotational velocity when a prescribed time has elapsed from the first controlling, and third controlling the hammer to intermittently rotate at a third rotational velocity lower than the second rotational velocity when a predetermined time has elapsed from the second controlling.

With this configuration, the method includes first controlling the hammer to continuously rotate at the first rotational velocity, second controlling the hammer to intermittently rotate at the second rotational velocity when the prescribed time has elapsed, and third controlling the hammer to intermittently rotate at the third rotational velocity when the predetermined time has elapsed, thereby preventing the fastener from being supplied to an excessive torque.

### Advantageous Effects of Invention

As described above, a power tool capable of preventing a head of a fastener from being broken can be provided.

### BRIEF DESCRIPTION OF DRAWINGS

In the drawings;

FIG. 1 is a cross-sectional view of an electronic pulse driver according to a first embodiment of the present invention;

FIG. 2 is an exploded perspective view ambient to a gear mechanism;

FIG. 3 is a rear perspective view showing a fan of the electronic pulse driver;

FIG. 4 is a block diagram of the electronic pulse driver;

FIG. 5 is a graph illustrating a control process of the electronic pulse driver when a fastener is tightened in a drill mode;

FIG. 6 is a graph illustrating the control process of the electronic pulse driver when a fastener is tightened in a clutch mode;

FIG. 7 is a diagram illustrating an initial activation phase of the control process in the clutch mode based on a positional relationship between a hammer and an anvil;

FIG. 8 is a diagram illustrating the initial activation phase of the control process in the clutch mode based on a rotational direction of the hammer;

FIG. 9 is a graph illustrating the control process for tightening a fastener in a pulse mode;

FIG. 10 is a graph illustrating a control process for tightening a self-drilling screw in a pulse mode according to a second embodiment of the present invention;

FIG. 11 is a diagram showing various states of the self-drilling screw as the self-drilling screw is tightened in a steel plate in the pulse mode; and

FIG. 12 is graphs showing an initial activation phase of the control process in the clutch mode based on the rotational direction of a motor according to a modification of the present invention.

### DESCRIPTION OF EMBODIMENTS

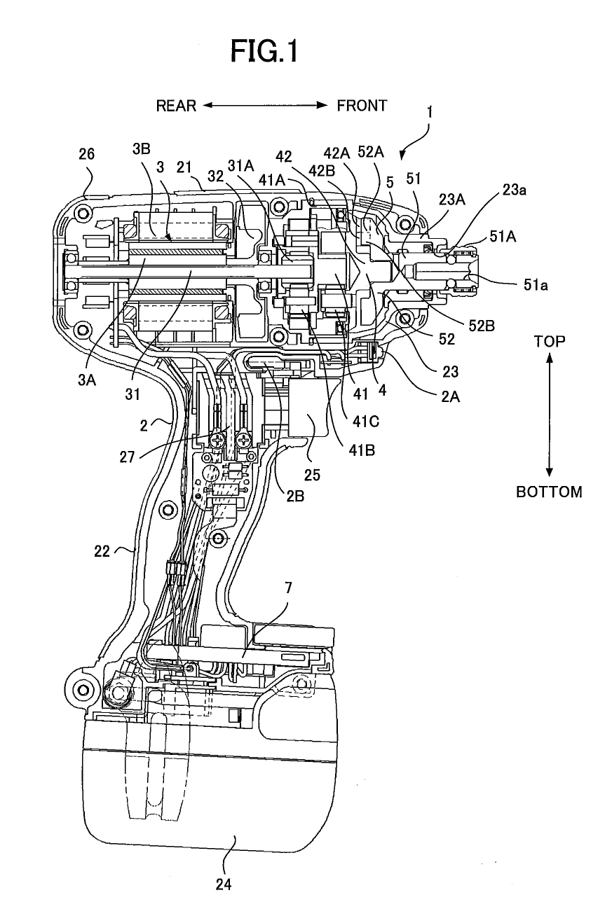

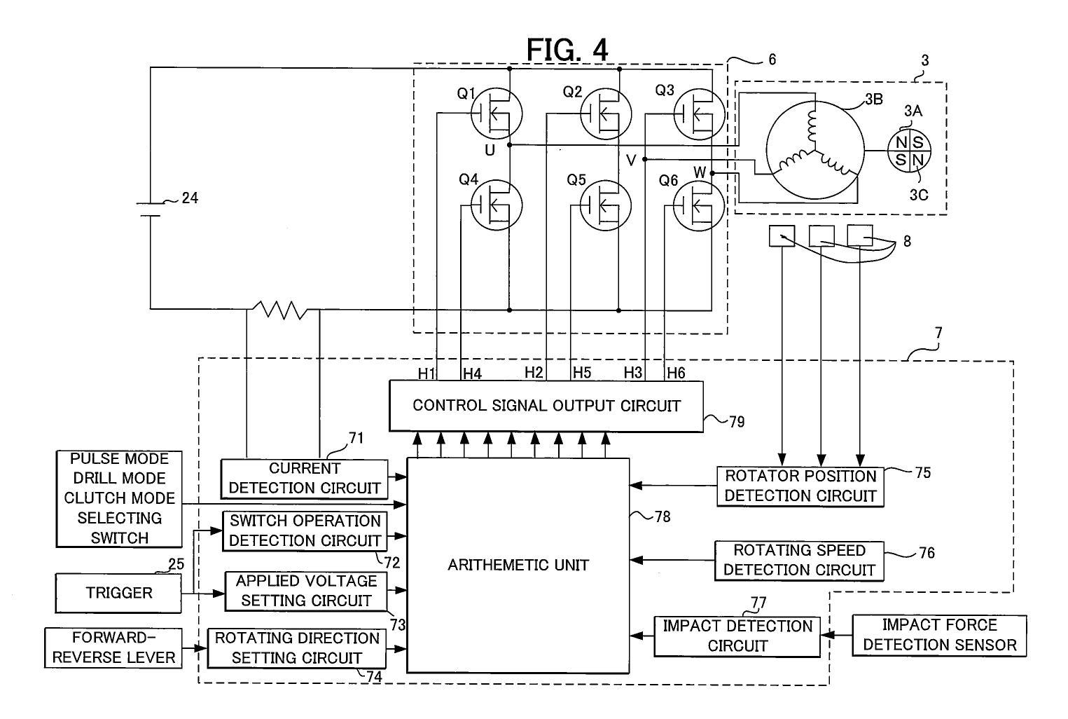

Next, a power tool according to a first embodiment of the present invention will be described while referring to FIGS. 1 through 9. FIG. 1 shows an electronic pulse driver 1 serving as the power tool of the first embodiment. The electronic pulse driver 1 is primarily configured of a housing 2, a motor 3, a hammer unit 4, an anvil unit 5, an inverter circuit 6, a control unit 7, and a rotational position detecting element 8 (hall element, FIG. 4). The housing 2 is formed of a resin material and constitutes the outer shell of the electronic pulse driver 1. The housing 2 is configured primarily of a substantially cylindrical body section 21, and a handle section 22 extending from the body section 21.

The motor 3 is disposed inside the body section 21 and oriented with its axis aligned in the longitudinal direction of the body section 21. The hammer unit 4 and the anvil unit 5 are juxtaposed on one axial end of the motor 3. In the following description, forward and rearward directions are defined as directions parallel to the axis of the motor 3, with the forward direction (i.e., the direction toward the front side of the electronic pulse driver 1) being from the motor 3 toward the hammer unit 4 and the anvil unit 5. A downward direction is defined as the direction from the body section 21 toward the handle section 22, and left and right directions are defined as directions orthogonal to the forward and the rearward directions and the upward and the downward directions.

A hammer case 23 is disposed at a forward position within the body section 21 for housing the hammer unit 4 and the anvil unit 5. The hammer case 23 is formed of a metal and is substantially funnel-shaped with its diameter growing gradually narrower toward the front end, which faces forward. The hammer case has a front end portion formed with an opening 23a. The hammer case 23 also has a bearing metal 23A provided on the inner wall of the hammer case 23 defining the opening 23a for rotatably supporting the anvil unit 5.

A light 2A is held in the body section 21 at a position beneath the hammer case 23 and near the opening 23a. When a bit (not shown) is mounted in an end tool mounting part 51 described later as the end tool, the light 2A can irradiate light near the front end of the bit. A dial 2B is also provided at the rear side of the light 2A on the body section 21. The dial 2B is for switching an operating mode and rotatably operated by the operator. The light 2A and the dial 2B are both disposed on the body section 21 at positions substantially in the left-to-right center thereof An intake and an outlet (not shown) are also formed in the body section 21 through which external air is drawn into and discharged from the body section 21 by a fan 32 described later. A display unit 26 is disposed on top of the body section 21 at the rear edge thereof The display unit 26 indicates the operating mode which is currently selected among a drill mode, a clutch mode, and a pulse mode.

The handle section 22 is integrally configured with the body section 21 and extends downward from a position on the body section 21 in substantially the front-to-rear center thereof A switch mechanism 27 is built into the handle section 22. A battery 24 is detachably mounted on the bottom end of the handle section 22 for supplying power to the motor 3 and the like. A trigger 25 is provided in the base portion of the handle section 22 leading from the body section 21 at a position on the front side serving as the location of user operations.

As shown in FIG. 1, the motor 3 is a brushless motor primarily configured of a rotor 3A including an output shaft 31, and a stator 3B disposed in confrontation with the rotor 3A. The motor 3 is arranged in the body section 21 so that the axis of the output shaft 31 is oriented in the front-to-rear direction. The output shaft 31 protrudes from both front and rear ends of the rotor 3A and is rotatably supported in the body section 21 at the protruding ends by bearings. The fan 32 is disposed on the portion of the output shaft 31 protruding forward from the rotor 3A. The fan 32 rotates integrally and coaxially with the output shaft 31. A pinion gear 31A is provided on the forwardmost end of the portion of the output shaft 31 protruding forward from the rotor 3A. The pinion gear 31A rotates integrally and coaxially with the output shaft 31.

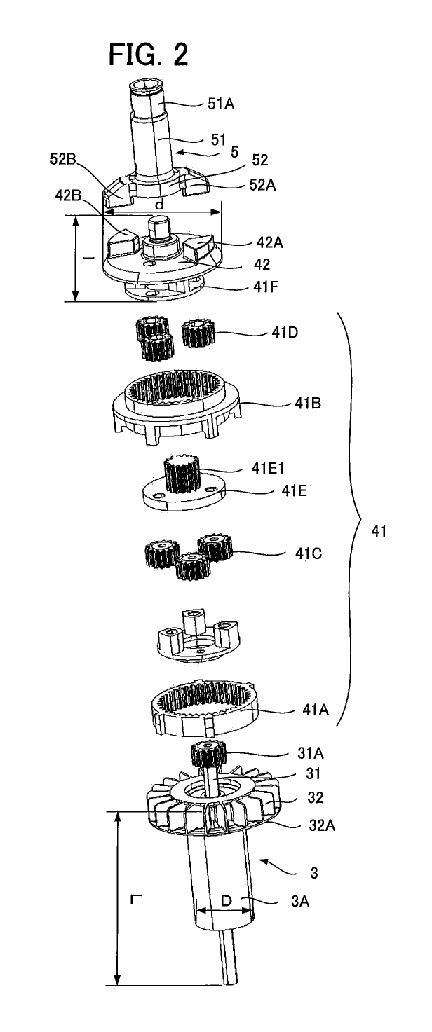

The hammer unit 4 is housed in the hammer case 23 on the front side of the motor 3. The hammer unit 4 primarily includes a gear mechanism 41, and a hammer 42. As shown in FIG. 2, the gear mechanism 41 is a two-stage planetary gear mechanism and includes outer ring gears 41A, 41B, planetary gears 41C and 41D respectively configured of three gears, and carriers 41E, 41F. The outer ring gears 41A, 41B are fixedly housed in the hammer case 23.

The first stage of the planetary gear mechanism will be described. The three planetary gears 41C are positioned around the pinion gear 31A as a sun gear and are meshingly engaged with the pinion gear 31A and the outer gear 41A. The three planetary gears 41C are rotatably supported on the carrier 41E having a sun gear 41E1. With this configuration, as the rotation of the pinion gear 31A, the three planetary gears 41C orbit the pinion gear 31A so that a rotation decelerated by this revolution is transmitted to the sun gear 41E1 of the carrier 41E. Similarly, the rotation of the motor is decelerated in the second stage (41E1, 41B, 41D, 41F) of the planetary gear mechanism and then transmitted to the hammer 42.

The hammer 42 is defined in the front portion of a planet carrier constituting the planetary gear mechanism. The hammer 42 includes a first engaging protrusion 42A disposed at a position offset from the rotational center of the planet carrier and protruding forward, and a second engaging protrusion 42B disposed on the opposite side of the rotational center of the planet carrier from the first engaging protrusion 42A.

The anvil unit 5 is disposed in front of the hammer unit 4 and primarily includes the end tool mounting part 51, and an anvil 52. The end tool mounting part 51 is cylindrical in shape and rotatably supported in the opening 23a of the hammer case 23 through the bearing metal 23A. The end tool mounting part 51 is formed with an insertion hole 51a penetrating the front end of the end tool mounting part 51 toward the rear end of the same for inserting the bit (not shown), and a chuck 51A is provided at the front end of the end tool mounting part 51 for holding the bit (not shown).

The anvil 52 is disposed in the hammer case 23 on the rear side of the end tool mounting part 51 and is integrally formed with the end tool mounting part 51. The anvil 52 includes a first engagement protrusion 52A disposed at a position offset from the rotational center of the end tool mounting part 51 and protruding rearward, and a second engagement protrusion 52B positioned on the opposite side of the rotational center of the end tool mounting part 51 from the first engagement protrusion 52A. When the hammer 42 rotates, the first engaging protrusion 42A collides with the first engagement protrusion 52A at the same time the second engaging protrusion 42B collides with the second engagement protrusion 52B, thereby transmitting the torque of the hammer 42 to the anvil 52.

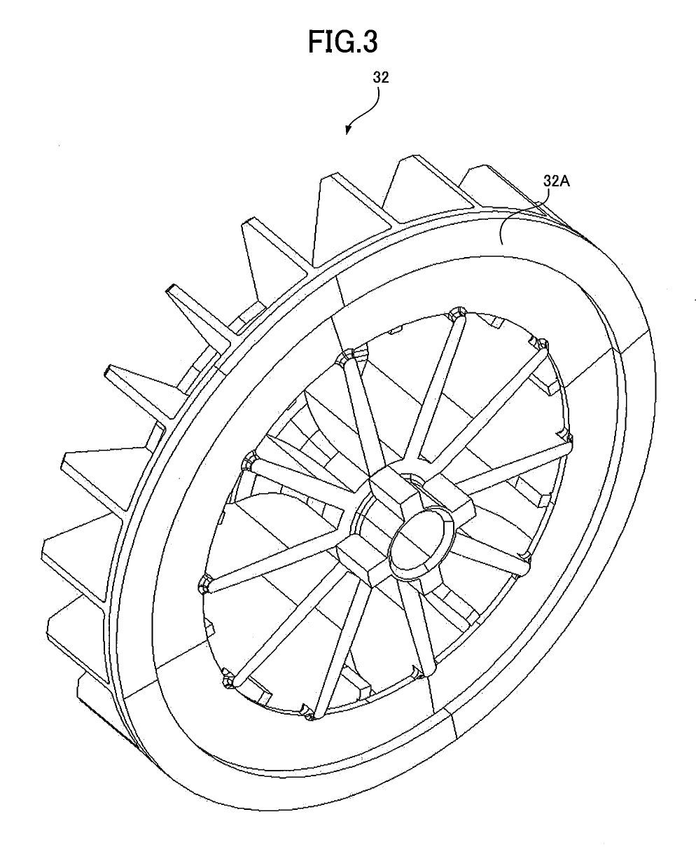

Generally, a kinetic energy K possessed by a rotating body is expressed by the equation K=Iω²/2. Therefore, the number of rotations of the motor 3 can be made higher than the number of rotations of the hammer 42 by employing the gear mechanism 41 disposed between the motor 3 and the hammer 42. In the following description, “number of rotations” means a number of rotations per unit time, for example round per minute (rpm). In order to increase the rotational kinetic energy K, a rotational inertial Im of the motor 3 is set greater than a rotational inertial Ih of the hammer 42. In the first embodiment, a generally annular spindle 32A is provided on the rear side of the fan 32 along the outer peripheral edge thereof, as shown in FIG. 3, and the weight and diameter of the rotor 3A are increased in order to generate a larger rotational inertial Im on the motor 3 side than the rotational inertial Ih of the hammer 42. Specifically, the diameter D of the rotor 3A is set to 22 mm, while the diameter d of the hammer 42 is set to 45 mm. Further, the length L of the rotor 3A in the front-to-rear direction (37.1 mm) is set longer than the length I of the hammer 42 in the front-to-rear direction (26.6 mm) The rotational inertial Im of the motor 3 is set to 5.8×10⁻⁶ kg·m², the number of rotations of the motor 3 is set between 0 and 17,000 rpm, the rotational inertial Ih of the hammer 42 is set to 1.1×10⁻⁵ kg·m², and the number of rotations of the hammer 42 is set between 0 and 1,100 rpm. Through these settings, the rotational inertial Im on the motor 3 side is greater than the rotational inertial Ih of the hammer 42. With this configuration, the size of the hammer 42 can be minimized and a more compact power tool can be achieved.

Further, the minimum required ratio of rotational inertias during the drill mode is Im:Ih=118:1, while the minimum required ratio during the pulse mode is Im:Ih=10:1. By reducing the size of the hammer 42 to an extent capable of meeting these ratios, it is possible to make the entire electronic pulse driver 1 more compact.

As shown in FIG. 4, the inverter circuit 6 is configured of six switching elements Q1-Q6 such as FETs connected in three phase bridge form.

The control unit 7 is mounted on a circuit disposed immediately above the battery 24 and is connected to the battery 24, the light 2A, the dial 2B, the trigger 25, the inverter circuit 6, and the display unit 26. The control unit 7 includes a current detection circuit 71, a switch operation detection circuit 72, an applied voltage setting circuit 73, a rotating direction setting circuit 74, a rotor position detection circuit 75, a rotating speed detection circuit 76, and an impact detection circuit 77, the arithmetic unit 78, and the control signal output circuit 79.

The rotational position detecting element 8 is provided in confrontation with a permanent magnet 3C of the rotor 3A and located at prescribed intervals along the circumferential direction of the rotor 3A (every 60 degrees, for example).

Next, the structure of a control system for driving the motor 3 will be described with reference to FIG. 4. In the first embodiment, the motor 3 is configured of a 3-phase brushless DC motor. The rotor 3A of this brushless DC motor is configured of a plurality (two in the first embodiment) of permanent magnets 3C each having an N-pole and an S-pole. The stator 3B is configured of 3-phase, star-connected stator coils U, V, and W.

The gates of six switching elements Q1-Q6 are connected to a control signal output circuit 79 and the drains or sources are connected to the stator coils U, V, and W. With this configuration, the switching elements Q1-Q6 perform switching operations based on switching element drive signals (drive signals H4, H5, H6, and the like) inputted from the control signal output circuit 79 and supplies power to the stator coils U, V, and W by converting the DC voltage of the battery 24 applied to the inverter circuit 6 to 3-phase (U-phase, V-phase, and W-phase) voltages Vu, Vv, and Vw.

Specifically, the rotational direction of the rotor 3A (stator coils U, V, and W) is controlled by output switching signals H1, H2, and H3 inputted from the control signal output circuit 79 to the switching elements Q1, Q2, and Q3 on the positive power supply side. Pulse width modulation signals (PWM signals) H4, H5, and H6 are supplied to the switching elements Q4, Q5, and Q6 on the negative power supply side so that the power supply amount to the stator coils U, V, and W, i.e., rotational velocity of the rotor 3A, is controlled.

The current detection circuit 71 is adapted to detect the electric current supplied to the motor 3 and outputs the electric current to the arithmetic unit 78. The switch operation detection circuit 72 is adapted to detect whether or not the trigger 35 is pulled and outputs the detection result to the arithmetic unit 78. The applied voltage setting circuit 73 outputs a signal to the arithmetic unit 78 in accordance with an operation amount (stroke) of the trigger 25.

The electronic pulse driver 1 further includes a forward-reverse lever (not shown) for switching a rotational direction of the motor 3. The rotating direction setting circuit 74 outputs to the arithmetic unit 78 a signal for switching the rotational direction of the motor 3 upon detecting an operation of the forward-reverse lever.

The rotator position detection circuit 75 is adapted to detect the position of the rotor 3A based on the signal from the rotational position detecting element 8 and outputs the detection result to the arithmetic unit 78. The rotating speed detection circuit 76 is adapted to detect the number of rotations of the rotor 3A based on the signal from the rotational position detecting element 8 and outputs the detection result to the arithmetic unit 78.

The electronic pulse driver 1 is provided with an impact force detection sensor for detecting the magnitude of impact generated in the anvil 52. A signal outputted from the impact force detection sensor is inputted into the arithmetic unit 78 after passing through the impact detection circuit 77.

While not shown in the drawings, the arithmetic unit 78 is configured of a central processing unit (CPU) for outputting a drive signal based on a program and control data, a ROM for storing the program and the control data, a RAM for temporarily storing process data during the process, and a timer. The arithmetic unit 78 generates output switching signals H1, H2, and H3 based on output signals from the rotating direction setting circuit 74 and the rotator position detection circuit 75, generates pulse width modifying signals (PWM signals) H4, H5, and H6 based on output signals from the applied voltage setting unit 73, and then outputs them to the control signal output circuit 79. The PWM signals may be outputted to the switching elements Q1, A2, and Q3 on the positive power supply side, and the output switching signals may be outputted to the switching element Q4, Q5, and Q6 on the negative power supply side.

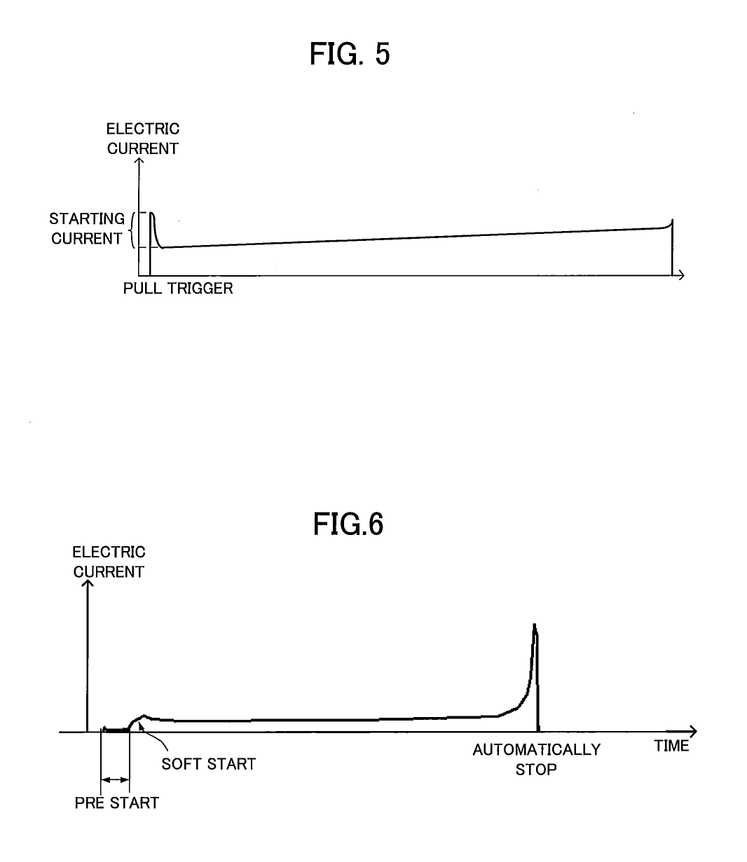

Next, the operating modes available in the electronic pulse driver 1 according to the first embodiment will be described with reference to FIGS. 5 through 9. The electronic pulse driver 1 has the drill mode, the clutch mode, and the pulse mode, for a total of three operating modes. The operator can switch the operating mode by operating the dial 2B.

In the drill mode, the hammer 42 and the anvil 52 are rotated as one. Therefore, this mode is normally used for tightening wood screws and the like. In this mode, the electronic pulse driver 1 gradually increases the supply of electric current to the motor 3 as a fastening operation progresses, as illustrated in FIG. 5.

In the clutch mode, the hammer 42 and the anvil 52 are rotated as one as shown in FIG. 6, and then the motor 3 is automatically halted when the electric current flowing to the motor 3 increases to a target value (target torque). The clutch mode is mainly used when emphasizing a proper tightening torque, such as when tightening cosmetic fasteners or the like that remain visible on the exterior of the workpiece after the fastening operation.

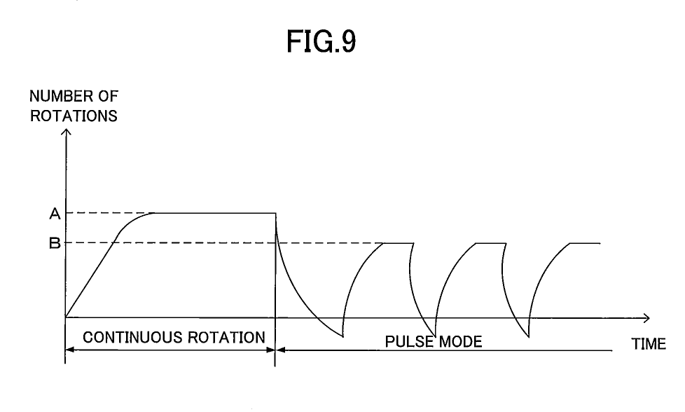

In the pulse mode, as shown in FIG. 9, the hammer 42 and the anvil 52 are continuously rotated as one, and then the rotating direction of the motor 3 is alternated between the forward direction (tightening direction) and reverse direction (loosening direction) when the electric current reaches a prescribed value (prescribed torque). The pulse mode is used primary when tightening long screws used areas that will not be outwardly visible. This mode can supply a strong tightening force, while reducing the reaction force from the workpiece.

Next, a control process performed by the control unit 7 when the electronic pulse driver 1 of the first embodiment performs the fastening operation will be described. A description of the control process will be omitted for the drill mode since the control unit 7 does not perform any special control in this mode. The description will not consider any sudden spikes in the electric current when applying a current for forward rotation because spikes in the electric current that occur when applying an electric current for normal rotation do not contribute to screw or bolt tightening. Such spikes in electric current can be ignored by providing approximately 20 ms of dead time, for example.

First, a control process during the clutch mode will be described with reference to FIGS. 6 to 8.

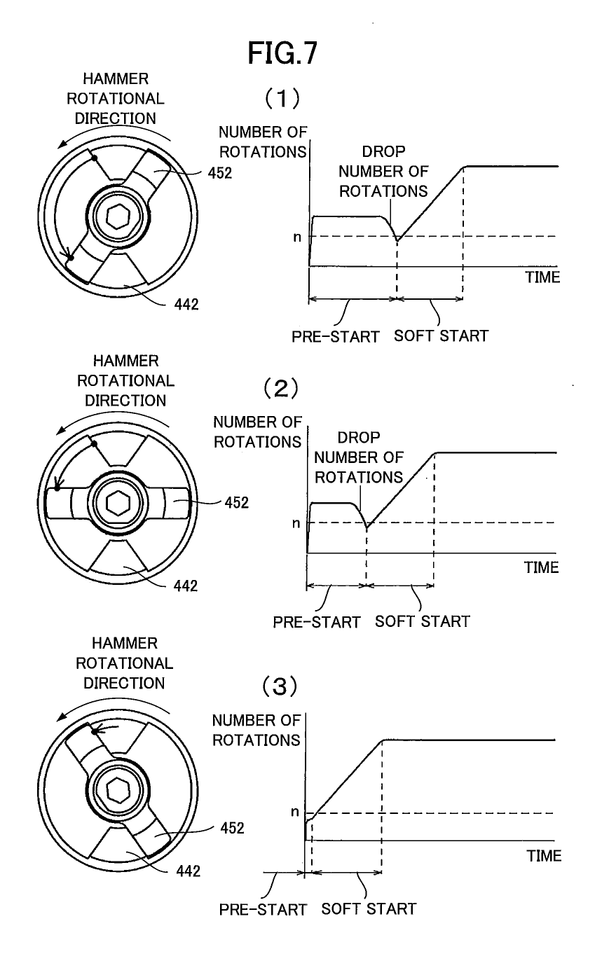

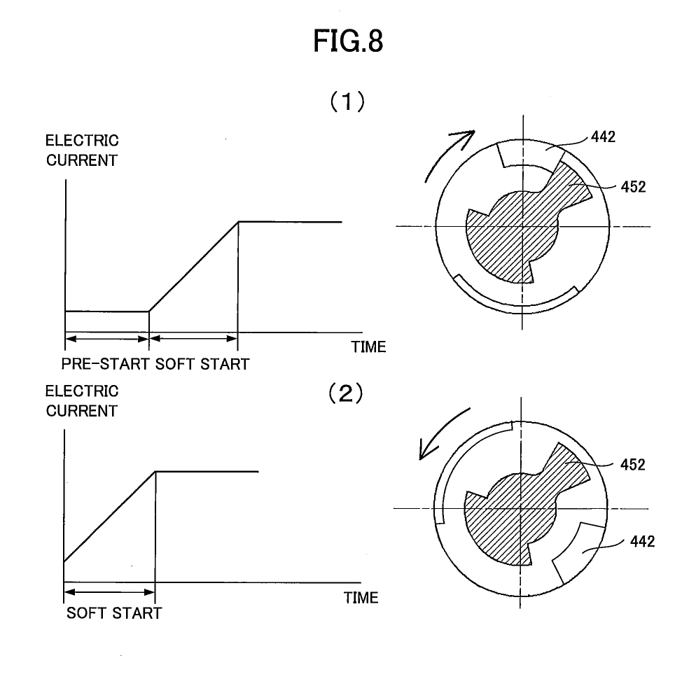

FIG. 6 is a graph illustrating the control process of the electronic pulse driver 1 when a fastener such as a bolt (hereinafter referred to as bolt) is tightened in the clutch mode. FIG. 7 is a diagram illustrating in the initial activation phase of the control process based on a positional relationship between the hammer 42 and the anvil 52. FIG. 8 is a diagram illustrating the initial activation phase of the control process based on the rotational direction of the hammer 42. In FIG. 7, the angle of clearance between the hammer 42 and the anvil 52 in their rotating direction is set to approximately 180 degrees.

In the clutch mode, the electric current is supplied to the motor 3 while the hammer 42 and the anvil 52 rotate together, and driving of the motor 3 is halted when the electric current reaches the target value (target torque). If the hammer 42 and the anvil 52 might be separated at the time the trigger is pulled, the anvil 52 is impacted so that this impact alone may transmit torque to the fastener that exceeds the target value. This problem is particularly pronounced when retightening a screw or the like that has already been tightened.

Therefore, the control unit 7 applies a prestart forward rotation voltage to the motor 3 for placing the hammer 42 in contact with the anvil 52 (a prestart operation) without rotating the anvil 52. In the first embodiment, the prestart forward rotation voltage is set to 1.5 V. The prestart operation is a control for placing the hammer 42 in contact with the anvil 52 before the fastening operation. Specifically, the prestart forward rotation voltage is set to a value that does not cause the anvil 52 to be rotated by contacting the hammer 42.

Since the conventional electronic pulse driver performs the prestart operation for a predetermined period of time regardless of the distance (positional relationship) between the hammer and the anvil, the conventional electronic pulse driver takes an excessive amount of time before beginning actual fastening operations.

To resolve this problem, the electronic pulse driver 1 according to the first embodiment modifies the duration of the prestart operation based on the positional relationship between the hammer 42 and the anvil 52. Specifically, as shown in FIG. 7, the control unit 7 determines that the hammer 42 is in contact with the anvil 52 (detects a load) when the number of rotations of the motor 3 is less than a threshold value n (200 rpm, for example). At this time, the control unit 7 ends the prestart operation and shifts to the next control process, such as a soft start operation described later.

Through this process, the control unit 7 can end the prestart operation and shift to the next control process more quickly when a circumferential distance between the hammer 42 and the anvil 52 is indicated in FIGS. 7 (2) and (3) of than when the circumferential distance is indicated in FIG. 7 (1). In the first embodiment, the control unit 7 detects an increase in load on the motor 3 (indicating contact between the hammer 42 and the anvil 52) based on a drop in the number of rotations of the motor 3, but the control unit 7 may detect an increase in load based on an increase in the electric current instead.

As shown in FIGS. 6 and 7, the control unit 7 shifts to the soft start operation after completing the prestart operation, and shifts to normal control after completing the soft start operation. The control unit 7 automatically cuts off the power supply to the motor 3 when the electric current supplied to the motor 3 increases to a target current (target torque set by adjusting the dial 2B). The soft start operation is a control process for gradually increasing the duty cycle of the PWM signal to a target value at a fixed rate of increase in order to prevent the generation of an excessive starting current when the motor 3 is actuated. In the first embodiment, the control unit 7 performs the soft start operation between the prestart operation and normal control, but the control unit 7 may also shift directly to normal control following the prestart operation without performing the soft start operation.

Next, a control process for loosening a fastener in the clutch mode (rotating the hammer 42 in reverse) will be described with reference to FIG. 8. In the example shown in FIG. 8, the hammer 42 and the anvil 52 are shaped so that they will contact each other at only one point along the circumferential direction.

As described above, when the electronic pulse driver 1 is tightening a bolt (rotating the hammer 42 clockwise in FIG. 8), the control unit 7 places the hammer 42 in contact with the anvil 52 in the prestart operation, as shown in FIG. 8(1), and subsequently shifts to the soft start operation. However, when loosening the bolt in the first embodiment (rotating the hammer 42 counterclockwise in FIG. 8), the control unit 7 omits the prestart operation, as shown in FIG. 8(2). As a result, the rotational speed of the hammer immediately before contacting the anvil is greater when the hammer is rotated in the reverse direction than when the hammer is rotated in the forward direction, i.e., the control unit 7 supplies to the motor the electric power which is greater when the hammer is initially rotated in the reverse direction than when the hammer is initially rotated in the forward direction.

In some cases, a tightened bolt cannot be loosened by applying the same force used for tightening the bolt, due to rust or other factors. In other cases, a screw cannot be loosened because the coefficient of kinetic friction between the screw and the workpiece during the fastening operation is less than the coefficient of static friction between the screw and the workpiece when attempting to loosen the screw. However, the electronic pulse driver 1 according to the first embodiment accelerates the hammer 42 for striking the anvil 52 during the soft start operation when the hammer 42 is rotated in the reverse direction. Accordingly, the electronic pulse driver 1 can reliably loosen a bolt or a screw even when the torque of the electronic pulse driver 1 is set to the same value for tightening and loosening. Although the loosening operation in FIG. 8(2) begins with the soft start operation, the fastening operation may start directly from normal control, i.e., the soft start operation may be omitted.

Next, a control process during the pulse mode according to the first embodiment will be described with reference to FIG. 9.

FIG. 9 is a graph illustrating the control process when a bolt is tightened in the pulse mode. When the operating mode of the electronic pulse driver 1 is set to the pulse mode and the operator squeezes the trigger 25, the control unit 7 drives the motor 3 continuously at a number of rotations A (17,000 rpm, for example). When the torque of the motor 3 reaches the prescribed value, the control unit 7 shifts the electronic pulse driver 1 into the pulse mode and begins driving the motor 3 in alternating forward and reverse directions. Since the pulse mode is used for applying a tightening force to the fastener through impacts, the bit can easily become unseated from a head of the fastener when the electronic pulse driver 1 shifts from continuous rotation to the pulse mode. Therefore, in the pulse mode, the electronic pulse driver 1 rotates the motor 3 in the forward direction at a number of rotations B (10,000 rpm, for example), which is lower than the number of rotations A. This configuration reduces the torque applied to the bit, preventing the bit from coming unseated from the head of the fastener when the electronic pulse driver 1 shifts to the pulse mode. In the pulse mode, the electronic pulse driver 1 alternates between forward and reverse rotations, but the electronic pulse driver 1 may instead alternate between a forward rotation and a halted state, for example, provided that the motor 3 is driven to rotate intermittently in the forward direction.

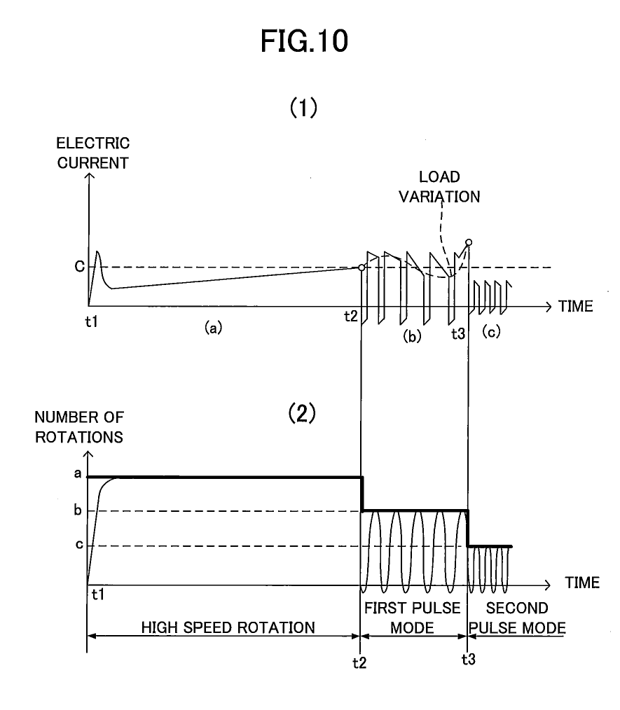

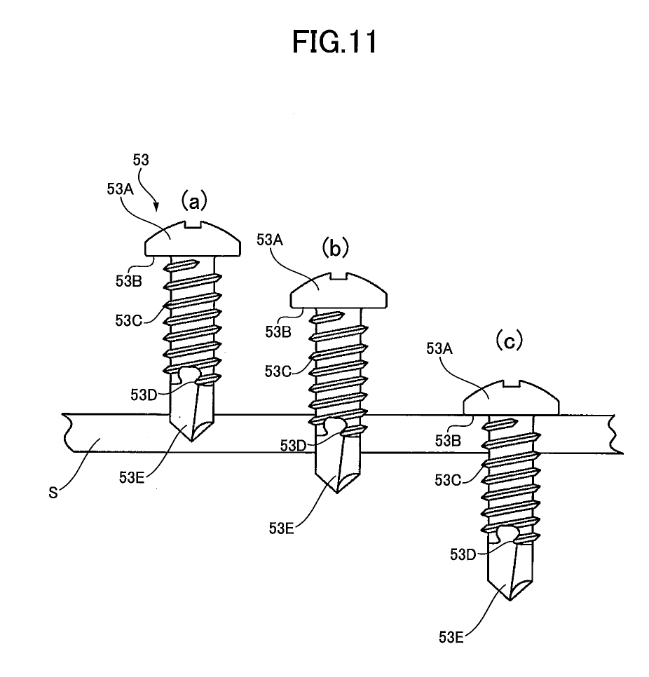

Next, an electronic pulse driver 201 according to a second embodiment of the present invention will be described with reference to FIGS. 10 and 11.

FIG. 10 is a graph illustrating the control process performed for screwing a self-drilling screw 53 into a steel plate S in the pulse mode. FIG. 11 shows various states of the self-drilling screw 53 as the self-drilling screw 53 is tightened into the steel plate S in the pulse mode. The self-drilling screw 53 has a drill-bit-like blade on its tip for drilling a hole in the steel plate S. As shown in FIG. 11, the self-drilling screw 53 is configured of a screw head 53A, a bearing surface 53B, a threaded part 53C, a thread tip 53D, and a drill part 53E.

In the pulse mode of the second embodiments, the control unit 7 performs PWM control in order to vary the number of rotations of the motor 3. When the operator first squeezes the trigger 25 (t1 in FIG. 10), the control unit 7 begin continuously driving the motor 3 at the number of rotations a. Since the electronic pulse driver 201 does not emphasize tightening at a proper torque in the pulse mode, steps corresponding to the prestart operation described for the clutch mode are not performed. The steps indicating the soft start operation have also been omitted from FIG. 10 for simplification.

Since the drill part 53E of the self-drilling screw 53 must drill a pilot hole in the steel plate S when the drill part 53E comes into contact with the steel plate S, as shown in FIG. 11(a), the control unit 7 drives the motor 3 to rotate at the high number of rotations a (17,000 rpm, for example), as shown in FIG. 10. After the tip of the self-drilling screw 53 advances into the steel plate S far enough that the thread tip 53D reaches the steel plate S, the friction generated between the threaded part 53C and the steel plate S produces resistance that increases the electric current (see FIG. 10 and FIG. 11(b)). Once the electric current surpasses the threshold value C (11A, for example), the control unit 7 shifts the operating mode to a first pulse mode for repeatedly alternating between forward and reverse rotations (t2 in FIG. 10).

In the first pulse mode of the second embodiment, the control unit 7 drives the motor 3 in the forward direction at the number of rotations b (6,000 rpm, for example), which is lower than the number of rotations a (FIG. 10(2)). When the bearing surface 53B becomes seated on the steel plate S (FIG. 11(c)), the electric current value increases abruptly. In the second embodiment, the control unit 7 shifts to a second pulse mode when the rate of increase in electric current exceeds a prescribed value (t3 in FIG. 10).

In the second pulse mode, the control unit 7 drives the motor 3 in the forward rotation at the threshold value c (3,000 rpm, for example), which is lower than the number of rotations b. That is, in the pulse mode according to the second embodiment, as the self-drilling screw 53 is screwed into the steel plate S, the number of rotations of the motor 3 (hammer 42) is lowered in a step-by-step manner, i.e., the rotational velocity of the hammer 42 is lowered in a step-by-step manner. Through this control, the electronic pulse driver 201 can avoid breaking or stripping the head of the self-drilling screw 53 due to the bit applying excessive torque to the same.

While the electronic pulse driver of the invention has been described in detail with reference to specific embodiments thereof, it would be apparent to those skilled in the art that many modifications and variations may be made therein without departing from the spirit of the invention, the scope of which is defined by the attached claims.

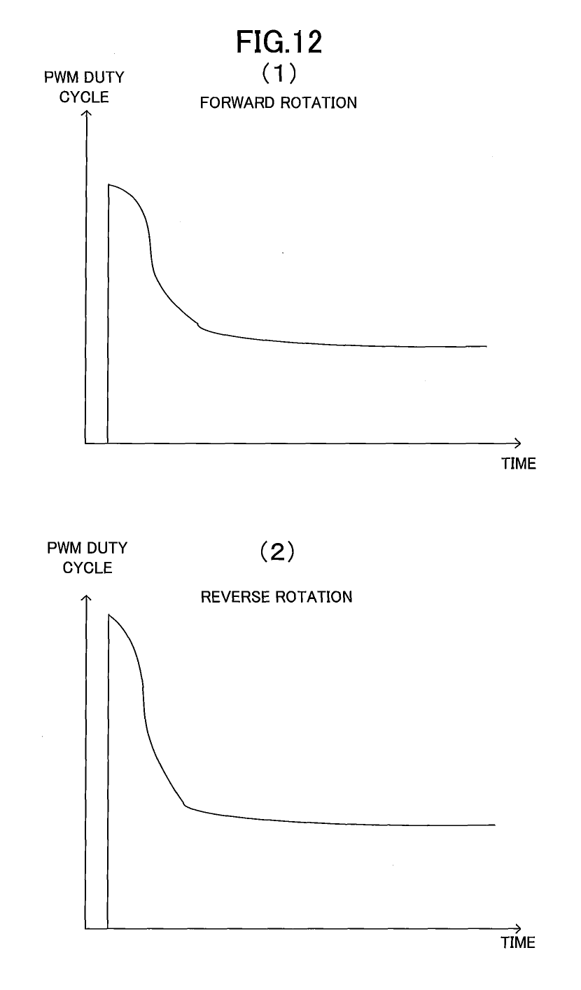

The control process for loosening (rotating in reverse) a fastener in the clutch mode described in the first embodiment may be implemented according to a different method. The graphs in FIG. 12 illustrate a modification of the control process in the clutch mode. Graph (1) in FIG. 12 shows control when driving the motor 3 in the forward direction, while graph (2) in FIG. 12 illustrates control when driving the motor 3 in the reverse direction.

As shown in FIG. 12, an electronic pulse driver 301 according to the modification supplies power to the motor 3 with a larger PWM duty cycle during the initial activation phase of the reverse rotation than during the initial activation phase of the forward rotation. As a result, the hammer 42 impacts the anvil 52 more strongly in the reverse rotation than in the forward rotation, facilitating loosening of the bolt. However, the PWM duty cycle for the reverse rotation is set within a range that does not produce overcurrent.

Instead of increasing the PWM duty cycle as described above, the electronic pulse driver 301 may be provided with a capacitor for storing electric charge and may simply supply the stored power to the motor 3 during the initial activation phase of the reverse rotation in order to increase the amount of power supply and, hence, increase the number of rotations of the motor 3. Further, the electronic pulse driver 301 may perform a control process so that the angle at which the hammer 42 rotates to contact the anvil 52 is larger for reverse rotation than for forward rotation. That is, by rotating the motor 3 forward for a very small time before driving the motor 3 in reverse, the electronic pulse driver 301 can increase the angle between the hammer 42 and the anvil 52 (acceleration distance) so that the hammer 42 more strongly impacts the anvil 52.

### REFERENCE SIGNS LIST

1 electrical pulse driver
2 housing
3 motor
3A rotor
4 hammer unit
5 anvil unit
42 hammer
52 anvil
7 control unit

1. A power tool for tightening a fastener comprising:
a motor;
a hammer intermittently or continuously rotatable in a forward direction by the motor;
an anvil that is impacted by the hammer rotated in the forward direction; and
a control unit that controls the hammer to continuously rotate at a first number of rotations, and to intermittently rotate at a second number of rotations lower than the first number of rotations when a prescribed time has elapsed from the rotation of the hammer at the first number of rotations, and then to intermittently rotate at a third number of rotations lower than the second number of rotations when a predetermined time has elapsed from the rotation of the hammer at the second number of rotations.

2. The power tool according to claim 1, further comprising a detecting unit configured to detect an electric current flowing to the motor,
wherein the control unit controls the hammer to intermittently rotate at the second number of rotation when the electric current detected by the detecting unit exceeds a prescribed value, and the control unit controls the hammer to intermittently rotate at the third number of rotation when a rate of increase in the electric current detected by the detecting unit exceeds a predetermined value.

3. The power tool according to claim 1, wherein the hammer is rotatable alternately in the forward direction and a reverse direction by the motor, and the control unit controls the hammer to continuously rotate in the forward direction at the first number of rotations, and to rotate alternately in the forward direction and the reverse direction at the second number of rotations when the prescribed time has elapsed from the rotation of the hammer at the first number of rotations, and then to rotate alternately in the forward direction and the reverse direction at the third number of rotations when the predetermined time has elapsed from the rotation of the hammer at the second number of rotations.

4. The power tool according to claim 1, wherein the control unit controls the hammer to intermittently rotate at the third number of rotations when the fastener is seated on a workpiece.

5. A power tool for tightening a fastener comprising:
a motor;
a hammer intermittently or continuously rotatable in a forward direction by the motor;
an anvil that is impacted by the hammer rotated in the forward direction; and
a control unit that controls the hammer to continuously rotate at a first rotational velocity, and to intermittently rotate at a second rotational velocity lower than the first rotational velocity when a prescribed time has elapsed from the rotation of the hammer at the first rotational velocity, and then to intermittently rotate at a third rotational velocity lower than the second rotational velocity when a predetermined time has elapsed from the rotation of the hammer at the second rotational velocity.

6. The power tool according to claim 5, further comprising a detecting unit configured to detect an electric current flowing to the motor,
wherein the control unit controls the hammer to intermittently rotate at the second rotational velocity when the electric current detected by the detecting unit exceeds a prescribed value, and the control unit controls the hammer to intermittently rotate at the third rotational velocity when a rate of increase in the electric current detected by the detecting unit increases to a predetermined value.

7. The power tool according to claim 5, wherein the hammer is rotatable alternately in the forward direction and a reverse direction by the motor, and the control unit controls the hammer to continuously rotate in the forward direction at the first rotational velocity, and to rotate alternately in the forward direction and the reverse direction at the second rotational velocity when the prescribed time has elapsed from the rotation of the hammer at the first rotational velocity, and then to rotate alternately in the forward direction and the reverse direction at the third rotational velocity when the predetermined time has elapsed from the rotation of the hammer at the second rotational velocity.

8. The power tool according to claim 5, wherein the control unit controls the hammer to intermittently rotate at the third rotational velocity when the fastener is seated on a workpiece.

9. A power tool for tightening a fastener comprising:
a motor;
a hammer intermittently or continuously rotatable in a forward direction by the motor;
an anvil that is impacted by the hammer rotated in the forward direction; and
a power supply unit that continuously supplies an electric power to the motor, and then intermittently supplies the electric power to the motor in a first cycle when a prescribed time has elapsed from continuously supply of the electric power, and then intermittently supplies the electric power to the motor in a second cycle shorter than the first cycle when a predetermined time has elapsed from intermittently supply of the electric power in the first cycle.

10. A method for tightening a fastener using a power tool, the power tool including a motor, a hammer intermittently or continuously rotatable in a forward direction by the motor, and an anvil that is impacted by the hammer rotated in the forward direction, the method comprising:
first controlling the hammer to continuously rotate at a first number of rotations;
second controlling the hammer to intermittently rotate at a second number of rotations lower than the first number of rotations when a prescribed time has elapsed from the first controlling; and
third controlling the hammer to intermittently rotate at a third number of rotations lower than the second number of rotations when a predetermined time has elapsed from second controlling.

11. A method for tightening a fastener using a power tool, the power tool including a motor, a hammer intermittently or continuously rotatable in a forward direction by the motor, and an anvil that is impacted by the hammer rotated in the forward direction, the method comprising:
first controlling the hammer to continuously rotate at a first rotational velocity;
second controlling the hammer to intermittently rotate at a second rotational velocity lower than the first rotational velocity when a prescribed time has elapsed from the first controlling; and
third controlling the hammer to intermittently rotate at a third rotational velocity lower than the second rotational velocity when a predetermined time has elapsed from the second controlling.
